(19) United States
(12) Patent Application Publication
(10) Pub. No.: US 2010/0186452 A1
(43) Pub. Date: Jul. 29, 2010

(54) METHOD AND APPARATUS FOR BENDING AND TEMPERING A GLASS PANEL

(75) Inventors: Pete Harjunen, Nokia (FI); Veijo Valtonen, Tampere (FI); Mika Olan, Pirkkala (FI); Mikko Tanhuanpää, Tempere (FI)

Correspondence Address: BUCHANAN, INGERSOLL & ROONEY PC, POST OFFICE BOX 1404, ALEXANDRIA, VA, 22313-1404, US

(73) Assignee: GLASTON CORPORATION, Tampere (FI)

(21) Appl. No.: 12/600,944

(22) PCT Filed: Jun. 13, 2008
(86) PCT No.: PCT/FI08/50358

§ 371 Date: Apr. 14, 2010

(30) Foreign Application Priority Data
Jun. 18, 2007 (FI) 20075462

(51) Int. Cl. C03B 23/023; C03B 23/00

(52) U.S. Cl. 65/104; 65/268

(57) ABSTRACT

The invention relates to a method and apparatus for bending a glass panel. A heated flat glass panel is fed from a furnace onto a bending conveyor while the bending conveyor is in a straight configuration. The bending conveyor and the glass panel are arched to a desired curvature while the glass panel travels along the bending conveyor. The bent glass panel is passed from the bending conveyor onto a tempering conveyor present as its extension, which has been previously arched to a desired curve as early as or even prior to having the flat glass panel received by the straight bending conveyor.

The invention relates to a method for bending and tempering a glass panel, said method comprising the steps of
heating a glass panel in a heating furnace for bending and tempering
feeding a flat glass panel from the furnace onto a bending conveyor with the bending conveyor in a straight configuration
arching the bending conveyor and the glass panel to a desired curvature with the glass panel moving along the bending conveyor.

The invention relates also to an apparatus for bending and tempering a glass panel, said apparatus comprising
a heating furnace for heating glass panels to a bending temperature
a bending conveyor for bending glass panels, the bending conveyor comprising horizontal conveyor rolls
means for arching the bending conveyor to a curve matching the desired curvature of a glass panel and means for cooling the bent glass panel for tempering.

Such a method and apparatus are known for example from the Applicant's patent publication EP-1597208 (B1). In this prior known apparatus, the bending and tempering processes are conducted on one and the same conveyor, which limits the apparatus in terms of its production capacity.

On the other hand, the patent publication FI-101697 discloses a method and apparatus, wherein a bending conveyor and a cooling conveyor are present separately as extensions of each other. In this prior known apparatus, the bending conveyor is in a condition previously arched to a curve as it receives the glass. This is adverse for the reason that the glass is forced to bend at a single point of bending. Regarding the quality of a final product, it is beneficial that the glass should bend simultaneously over its entire bending distance.

It is an object of the invention to eliminate the capacity and quality problems associated with the above prior known solution and to provide a method and apparatus capable of producing high-quality tempered bent glass with a high capacity.

This object is achieved by a method presented in the appended claim 1. The object is also achieved by an apparatus presented in the appended claim 7. Preferred embodiments of the invention are presented in the dependent claims.

One exemplary embodiment of the invention will now be described more closely with reference to the accompanying drawings, in which

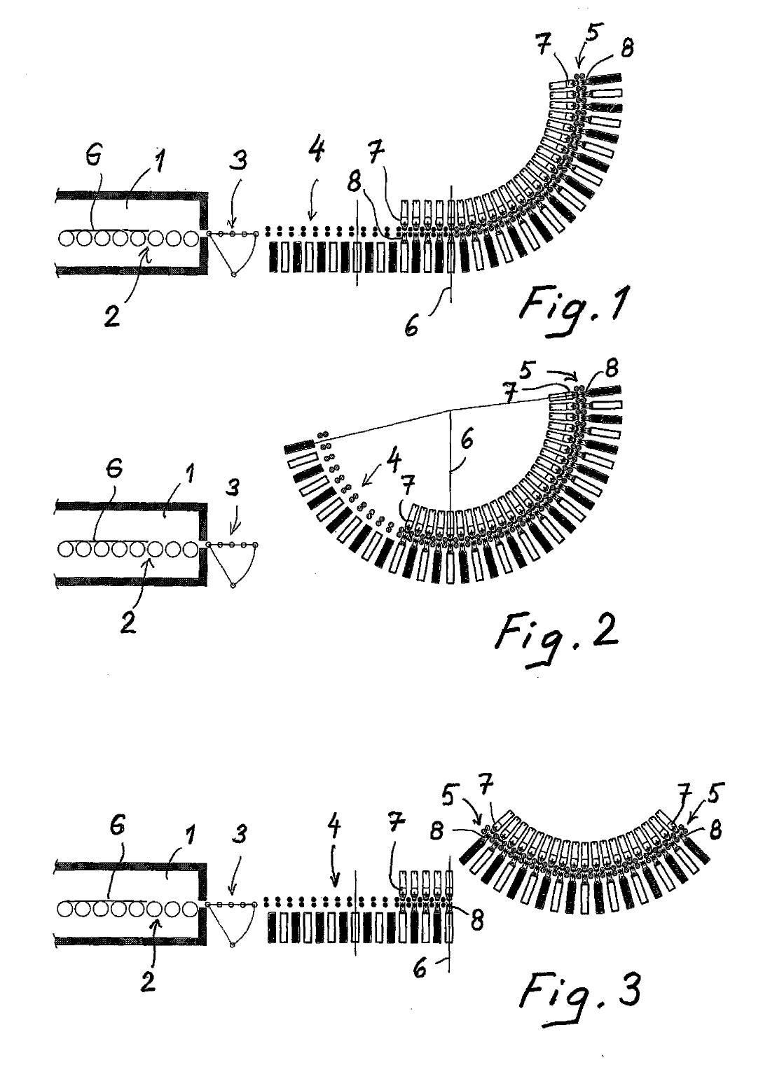

FIGS. 1-3 show schematically an apparatus of the invention in a side view during various working sequences.

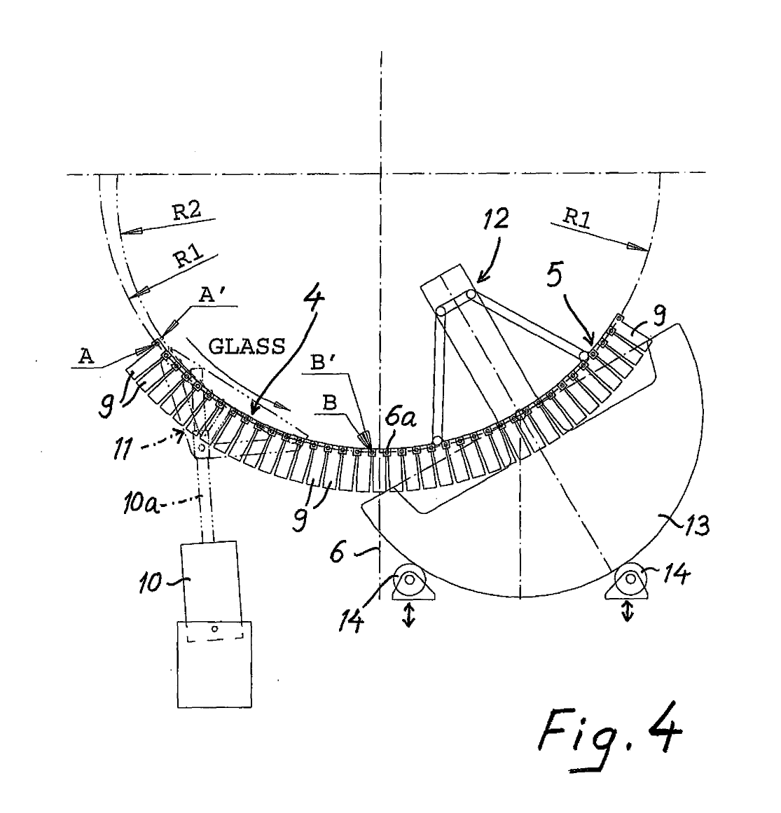

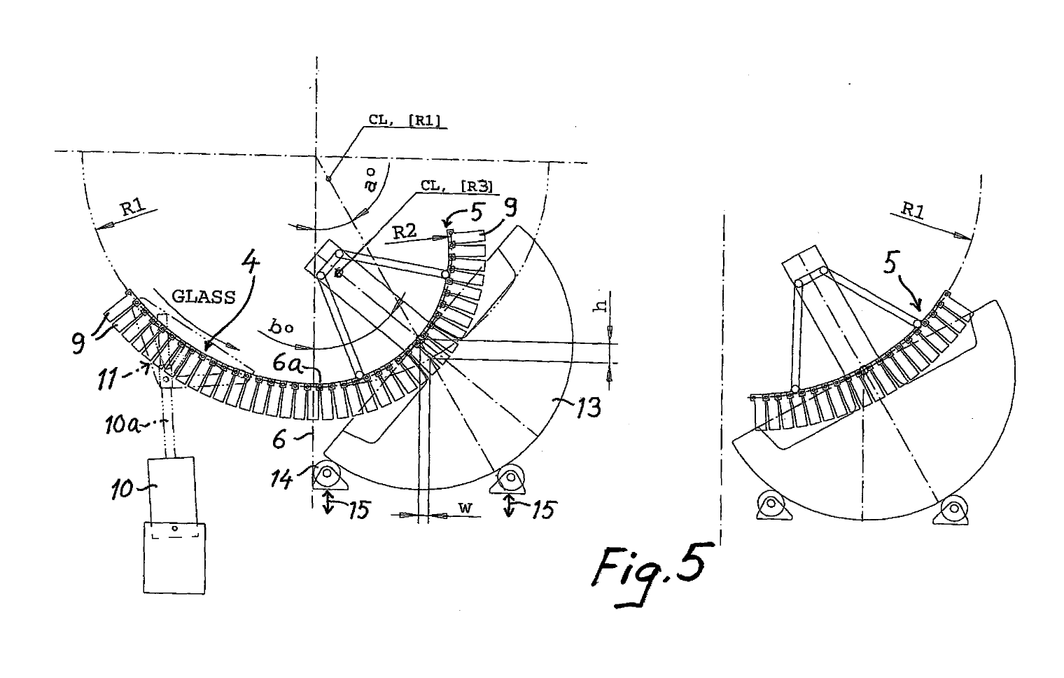

FIG. 4 shows more closely a bending conveyor and a tempering conveyor in a configuration arched to a desired radius of curvature, visualizing the arching of a bending conveyor 4, or at least its upstream end section, beyond a desired final curvature of the glass panel.

FIG. 5 shows more closely a bending conveyor and a tempering conveyor in such a configuration that a tempering conveyor 5 has been arched to a radius of curvature R3 which is smaller compared to a radius of curvature R1 of the bending conveyor 4.

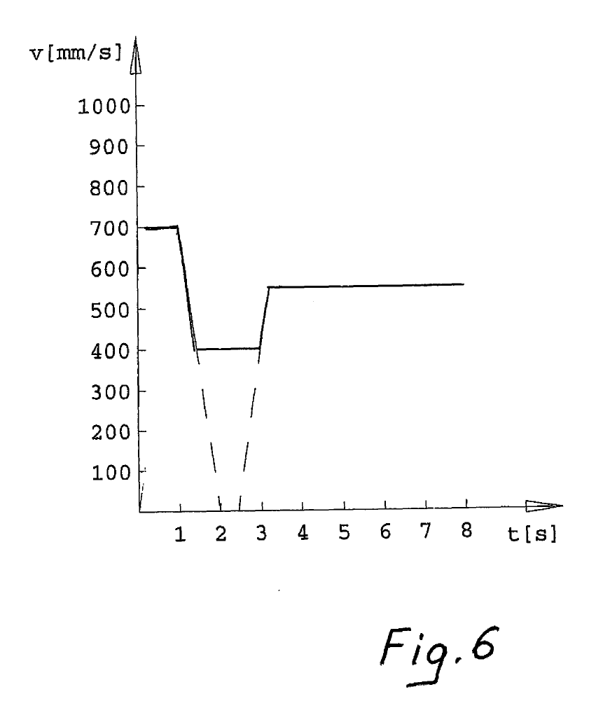

FIG. 6 visualizes variations in the traveling speed of a glass panel as it emerges from the furnace onto a bending conveyor and passes from the bending conveyor onto a tempering conveyor, and

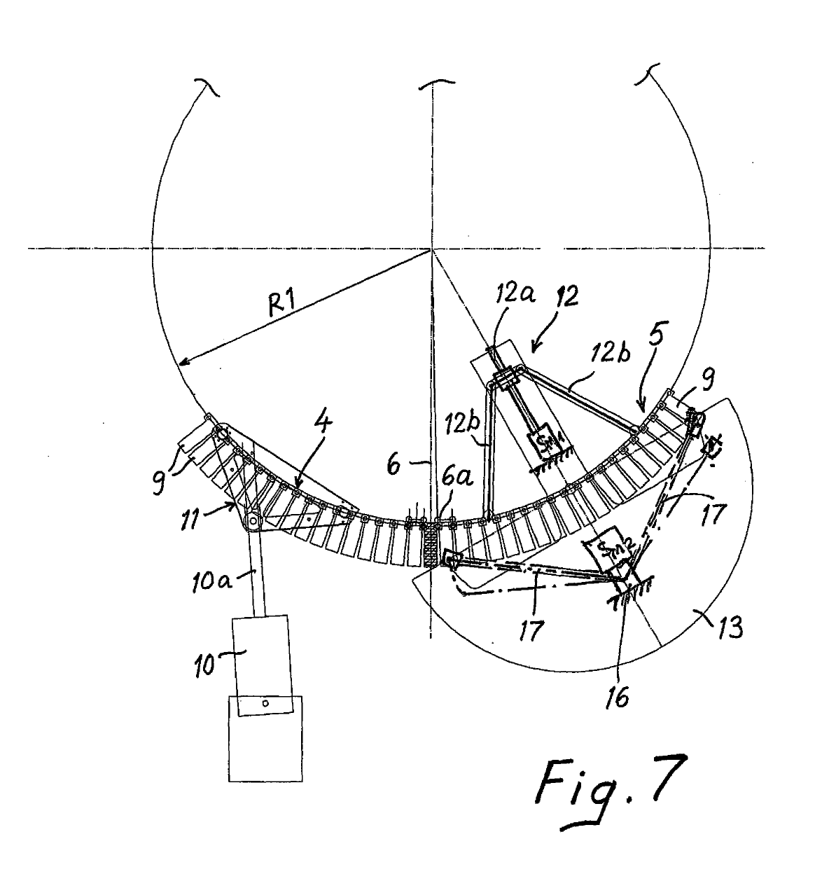

FIG. 7 shows an even closer view of actuators used for arching the tempering conveyor.

The apparatus according to the invention includes a heating furnace 1 for heating glass panels G therein to a bending temperature. From a furnace conveyor 2 the glass panel is passed by way of an intermediate conveyor 3 onto a bending conveyor 4, including horizontal conveyor rolls with press rolls thereabove. A gap between the conveyor rolls and the press rolls matches substantially the thickness of a glass panel. Present as an immediate extension of the bending conveyor 4 is a tempering conveyor 5, which also consists of horizontal conveyor rolls and press rolls spaced from the conveyor rolls by a distance matching the thickness of a glass panel. The tempering conveyor 5 is covered over its entire length by upper and lower tempering air enclosures 7 and 8, tracing a curvilinear outline of the conveyor. The bending conveyor 4 may also have tempering air enclosures 7 and 8 along its downstream end section. Reference numeral 6 represents a vertical line, along which the bending conveyor 4 and the tempering conveyor 5 can be disengaged from each other. The tempering conveyor 5 is typically slightly longer than the bending conveyor 4. Both conveyors have their press rolls provided with a drive, i.e. rotated at a peripheral speed equal to that of the conveyor rolls, as a result of which the press rolls function also as conveyor rolls.

In reference to FIGS. 4, 5 and 7, there are only shown link bodies 9 along both sides of the conveyors 4, 5, which are fitted with bearings for the conveyor rolls and the press rolls. The link bodies 9 are in turn connected to each other with a link mechanism (not shown), which forces the link bodies to pivot relative to each other over the same extent as the conveyor is being arched. Such a link mechanism has been described e.g. in the Applicant's patent EP-1385795 (B1). FIG. 4 illustrates a power unit 10 and a lever system 11, by means of which the bending conveyor 4 is adjustable in terms of its radius of curvature. The power unit 10 can be a servomotor, which by way of a clutch operates a ball screw 10a, which in turn pushes and/or pivots the lever system 11 upon which rests a bridge established by the link bodies 9. A gap, present in the link mechanism (not shown) which controls the pivoting action of the link bodies 9, allows for the upstream end section of the conveyor 4 to have a radius of curvature which is slightly smaller than that of the downstream end section.

In addition to the above, it is preferred that the entire bending conveyor 4, or at least its upstream end section, be arched to a radius of curvature R2 which is slightly smaller than a radius of curvature R1 desired for the glass. This serves to eliminate end section flatness and the final tempered glass is brought over its entire extent to the desired curvature R1.

On the other hand, FIG. 5 illustrates how the tempering conveyor 5 is maneuverable in vertical and horizontal directions (h and w) at the same time as the angle of its center axis CL changes. This way, the tempering conveyor 5 can have its curvature varied regardless of the bending conveyor 4, with an articulation point 6a between the conveyors 4, 5 remaining nevertheless stationary. As the desired radius of curvature R1 changes, a curvature adjustment for the tempering conveyor 5 is performed independently of the bending conveyor. During a curvature adjustment for the tempering conveyor 5 performed while the process is ongoing, the end of said conveyor may not become disengaged from the articulation point 6a common to the conveyors 4, 5. During a curvature adjustment, or immediately after the adjustment, the articulation point 6a for the conveyor 5 is set in position, e.g. by means of a photocell control. Thus, what is carried out during a curvature adjustment, or immediately thereafter, is an interpolating position-setting for the ends of these conveyors. In the conveying direction, the ends of the conveyors 4 and 5 are mechanically separate from each other in order to enable a curvature adjustment of the tempering conveyor 5 and to enable, whenever necessary, a disengagement of the tempering conveyor 5 from the bending conveyor 4. The downstream end of the bending conveyor 4 remains stationary at all times. Indicated by arrows 15 are power units for bringing rollers 14 up and down (vertical action h). In addition, the rollers 14 are able to travel (while maintaining the relative distance between themselves) in a horizontal direction at the same time as a swing frame 13 supporting the conveyor 5 is pivoted while supported upon the rollers 14. The swing frame 13 has its pivoting axis coinciding with the midpoint of an arch which extends through the articulated axles of the conveyor's 5 link bodies 9.

FIG. 7 illustrates an arching mechanism for the tempering conveyor 5, comprising a ball screw 12a, which is operated by a servomotor SM1 and which, through the intermediary of arms 12b, arches a bridge established by the link bodies 9, and at the same time the entire conveyor resting upon the link bodies 9. The arms 12b engage the conveyor 5 at a small distance from its ends. A second servomotor SM2 operates, by way of a herringbone gear 16, ball screws 17 which engage the conveyor 5 at its opposite outer ends.

The servomotors SM1 and SM2 are matched (position synchronized) with each other, such that various sections of the conveyor 5 become arched to the same extent. For this purpose, the servomotors can be provided e.g. with a control-designed electrical gearbox. In fact, the arching could be carried out with just one actuator, but the use of two actuators makes it possible to avoid inaccuracies in the curvature of a conveyor caused by gaps resulting from the wearing of links. Specifically, the curvatures along the mid-section and end sections can be retained the same.

The method according to the invention is implemented with the above-described apparatus as follows. A glass panel G is heated in a furnace 1 to a temperature appropriate for bending and tempering. The flat glass panel G is delivered from the furnace 1 onto a bending conveyor 4 while the latter is in a straight configuration (FIG. 1). A tempering conveyor 5 has been previously arched to a desired curve as early as or even prior to the flat glass panel is received by the straight bending conveyor 4. The glass panel's exit speed from the furnace is e.g. 700 mm/s (FIG. 6) and the speed is decelerated over the period of e.g. 1 second to a speed of 400 mm/s at the same time as the glass panel passes onto the bending conveyor 4. The exit speed from the furnace can also be lower, e.g. 550 mm/s, and the deceleration proceeds to a speed of less than 300 mm/s. Arching of the bending conveyor 4 to a desired curve R1 is initiated even before the glass panel's trailing end section has completely reached the bending conveyor 4. Arching of the bending conveyor 4 is performed very quickly, typically within 1-2 seconds. That period is enough for the glass panel's leading edge to reach a position in line with tempering air enclosures 7, 8 present at the downstream end of the bending conveyor 4. Tempering blast may be continuously ongoing and the speed of a bent glass panel is increased to some degree, as can be seen from FIG. 6. The increase of speed can be e.g. 10-40%. The deceleration of speed in the preceding stage is typically at least 30%, preferably more than 40%.

Over the course of a bending process, it is preferred that the conveyor 4, or at least its upstream end section, be arched beyond what is the desired final curvature R1 for a glass panel. This has been visualized in FIG. 4, wherein the bending conveyor 4, or at least its upstream end section, has been arched with a bending radius R2 which is smaller than the desired final curvature R1 of a glass panel. This over-arching serves to diminish or eliminate the end-section flatness of a glass panel, such that the glass panel acquires, all the way to its ends, the desired curvature R1 as precisely as possible. R2 is several percent, even up to 5-10%, smaller than R1. If desired, the upstream end section of the conveyor 4 can be adapted to be arched separately. However, the gaps in link mechanisms are generally enough to provide a sufficient over-arching for the conveyor's 4 upstream end section. In addition to this, the entire bending conveyor 4 can be arched, proceeding from its stationary downstream end, slightly beyond the desired final curvature of a glass panel.

FIG. 5 illustrates, in an overstated manner for clearer visualization, the way how the tempering conveyor 5 can also be arched during the process to a radius of curvature R3 slightly smaller or larger than the desired radius of curvature R1. This arching of the tempering conveyor 5 to the smaller or larger radius R3 is first of all enabled by virtue of the previously mentioned freedoms of movement (h, w and an angle α), as well as by virtue of the mentioned interpolating position-setting, while the articulation point 6a between the conveyors 4, 5 remains stationary. Arching of the tempering conveyor 5 during the process is sufficiently slight not to cause a change in the glass panel's radius of curvature R1, but nevertheless clamps the glass panel between conveyor rolls and press rolls to such a tightness that the glass panel is able to proceed upward even along a steep arch without slipping. Thus, tempered glass panels can be discharged even vertically straight upward to an appropriate manipulator, which receives the glass panel. However, if necessary, the tempering conveyor 5 can also be disengaged from the bending conveyor 4, enabling the tempering conveyor 5 to be pivoted as a whole for diminishing the vertical drop between its discharge end and midpoint (see e.g. FIG. 3). Consequently, the glass panel can be discharged from the tempering conveyor 5 at quite a low angle with respect to the horizontal plane, without having to move the glass panel in vertical direction.

Whenever the apparatus is used to produce bent and tempered glass panels in succession with the same desired radius of curvature R1, the curvature of the tempering conveyor 5 is retained the same at all times, except for a very slight increase of curvature during the process. Other than that, the only time that the curvature of the tempering conveyor 5 needs changing is when the desired curvature R1 changes.

The method and apparatus according to the invention are also particularly apt for the production of bidirectionally curved glass panels. In this case, the rolls are also subjected to deflection, as described e.g. in the Applicant's patent publication EP-1597208 (B1).

1. A method for bending and tempering a glass panel, said method comprises:
heating a glass panel in a heating furnace for bending and tempering
feeding a flat glass panel from the furnace onto a bending conveyor with the bending conveyor in a straight configuration
arching the bending conveyor and a glass panel to a desired curvature while the glass panel travels along the bending conveyor,
wherein a bent glass panel is passed from the bending conveyor onto a tempering conveyor present as its extension, which has been previously arched to a desired curve as early as or even prior to a flat glass panel is received onto the straight bending conveyor.

2. A method as set forth in claim 1, wherein during the course of a bending process, the bending conveyor or at least its upstream end section is arched beyond a desired final curvature of the glass panel, i.e. the bending conveyor or at least its upstream end section is arched with a bending radius, which is smaller than a bending radius for the desired final curvature of the glass panel.

3. A method as set forth in claim 1, wherein the tempering conveyor is arched during the course of a tempering process to a bending radius slightly smaller than the desired bending radius of a glass panel, yet in such a way that the glass panel does not change its curvature on the tempering conveyor but, instead, the glass panel only becomes tightly clamped between the upper and lower tempering conveyor rolls.

4. A method as set forth in claim 1, wherein in the process of arching the bending conveyor and/or the tempering conveyor, an articulation point between the conveyors remains stationary.

5. A method as set forth in claim 1, wherein in the tempering conveyor is disengaged from the bending conveyor and the tempering conveyor is pivoted as a whole in such a way that the vertical drop between its discharge end and its midpoint decreases without changing the tempering conveyor in terms of its curvature.

6. A method as set forth in claim 1, wherein during the passage of a glass panel onto the bending conveyor, the glass panel has its speed decelerated by at least 30% of the speed at which the glass panel emerges from the furnace, and the glass panel has its speed accelerated again as the glass panel is passed from the bending conveyor onto the tempering conveyor.

7. An apparatus for bending and tempering a glass panel, said apparatus comprises:
a heating furnace for heating glass panels to a bending temperature
a bending conveyor for bending glass panels, the bending conveyor comprising horizontal conveyor rolls
means for arching the bending conveyor to a curve matching the desired curvature of a glass panel and means for cooling the bent glass panel for tempering,
wherein the bending conveyor is adapted to receive a flat glass panel while itself in a straight configuration and the bending conveyor is followed by an arching-ready tempering conveyor, which is already in a configuration arched to a desired curve even as the bending conveyor is still in a straight configuration.

8. An apparatus as set forth in claim 7, wherein the bending conveyor or at least its upstream end section is adapted to be arched to a radius of curvature smaller than a desired radius of curvature of the glass panel present on the bending conveyor.

9. An apparatus as set forth in claim 7, wherein the tempering conveyor is maneuverable in vertical and horizontal directions at the same time as the angle of its center axis is variable, while an articulation point between the conveyors remains stationary during said maneuvering.

10. An apparatus as set forth in claim 7, wherein the tempering conveyor is capable of being disengaged from the bending conveyor and the tempering conveyor is capable of being pivoted as a whole in such a way that the vertical drop between its discharge end and its midpoint decreases without changing the tempering conveyor in terms of its curvature.
